(19) United States
(12) Patent Application Publication
(10) Pub. No.: US 2009/0254465 A1
(43) Pub. Date: Oct. 8, 2009

(54) Recording Resource Usage

(75) Inventor: Heiko Oester, Forchheim (DE)

Correspondence Address: BACON & THOMAS, PLLC, 625 SLATERS LANE, FOURTH FLOOR, ALEXANDRIA, VA, 22314-1176, US

(73) Assignee: GIESECKE & DEVRIENT GMBH, München (DE)

(21) Appl. No.: 12/297,169

(22) PCT Filed: Apr. 10, 2007
(86) PCT No.: PCT/EP2007/003178

§ 371 Date: Jan. 23, 2009

(30) Foreign Application Priority Data
Apr. 11, 2006 (DE) 10 2006 016 994.8

(51) Int. Cl. G06Q 10/00; G06F 12/02; G06F 21/00; G06F 21/22; G06Q 30/00

(52) U.S. Cl. 705/34; 711/101; 711/115; 726/26; 705/30; 711/E12.002; 711/E12.008

(57) ABSTRACT

A security module with a processor, on which applications from various providers are installed, includes a recording device for recording the access of the applications to resources of the security module, recording the total resource usage caused by an application and allocates the relevant applications to a charging station for subsequent charging. The recorded usage data are allocated to usage data sets and/or data sets on the security module directly connected to the relevant application and/or the provider thereof and thus permits billing of total resource use of each application or all the applications of a provider.

The present invention relates to a method and apparatus for recording the resource consumption of installed applications, in particular ones installed on security modules.

Nowadays portable data carriers such as chip cards are employed for utilizing all sorts of services by users. Said data carriers mostly employ proprietary communication interfaces and are in each case suitable only for utilization of that service offered by the provider of the data carrier in question. This applies in particular to mobile communication cards, which can be used exclusively for mobile communication over a mobile communication network, but also to other kinds of chip cards, e.g. bank cards, account cards, cash cards and credit cards, access cards and identification cards, and the like. To permit the utilization of the particular service to be billed to the user, the portable data carriers collect proprietary usage data and/or transaction data coordinated only with the service in question and representing the extent of utilization. For example, in the case of mobile communication cards, access data are collected that represent the extent of usage of the mobile communication network.

For the user of such portable data carriers, this technological diversification and (as yet) lacking standards result in the problem that a specific data carrier must be carried and employed for almost every service. Due to the different usage data collection in each case, the corresponding proprietary data acquisition methods and sometimes also due to operating system restrictions, it is currently not readily possible to install and use application programs from third-party suppliers on a portable data carrier, since the utilization of the particular services of said third-party supplier cannot be logged in the same form as with conventional specialized data carriers.

WO 2005/050968 proposes a method by which the utilization of different mobile communication services by a user is logged by a recording device installed on a mobile station. This has the disadvantage that, on the one hand, the utilization of mobile services is recorded by the mobile station itself and the recorded usage data can be tampered with upon their insecure transfer between the mobile communication card and the mobile station. Furthermore, it is not apparent how this teaching is applicable to the problem described above.

WO 2004/021131 discloses a method for accounting for a utilization of services of a computer system via a mobile terminal of the user. However, this teaching, cannot be used in the context of the present scenario of logging the extent of a utilization of services from different third-party suppliers installed on a portable data carrier.

U.S. Pat. No. 6,543,686 discloses a method for billing mobile communication services to a user of a mobile station which are utilized by means of a mobile communication card inserted in the mobile terminal. The corresponding recording is carried out by a device of the mobile communication card which can record the utilization of different resources of the mobile communication card and bill the user therefor. However, this usage data acquisition records the extent of a resource usage only in connection with the utilization of the original mobile communication services offered by the provider of the mobile communication card.

It is therefore the object of the present invention to provide a flexible and reliable recording of a utilization of services from any third-party suppliers by means of a security module.

This object is achieved according to the invention by an apparatus and method having the features of the independent claims. The claims dependent thereon describe advantageous embodiments and developments of the invention.

A security module, preferably a portable data carrier or a data carrier firmly installed in a terminal, which can execute by means of a processor different applications present in a non-volatile memory of the security module comprises a recording device for recording a usage of resources of the unit by certain applications present on the security module. The recorded usage data are stored in the non-volatile memory and transferred to an accounting center to thereby account for the utilization of resources of the unit vis-à-vis an accounting center. When a resource usage occurs, the recording device first determines the application that is utilizing the resources and to which the usage data are to be assigned. The usage data are then stored in their assignment to the application in question so as to permit an accounting on the basis of the usage data. The assignment of the usage data to the corresponding application can be obtained here by storing the usage data in a usage data record of the application in question or by any other assignment method allowing a unique linkage of usage data and applications, e.g. by references, pointers, suitable data structures or the like.

The recording device can record in particular the resource usage of those applications that are made available for execution on the unit by one or more suppliers which are in each case different from the provider of the unit. For this purpose, the usage data record is present in the form of a supplier data record linked to the particular supplier, all usage data being directly assigned to said data record that result from a resource usage of an application made available by said supplier. There is thereby obtained information that can be used technically and for business purposes about which third-party suppliers utilize resources of the unit and to what extent this is done. The thus determined measure of the extent of resource utilization by applications of a third-party supplier can then be the basis for billing the resource usage to the particular supplier.

The usage data to be recorded for a certain application can be coordinated flexibly with the particular application, e.g. by selecting for each individual application certain resources whose usage is to be recorded. For example, when the application is installed on the security module it is also possible to install, and store in the non-volatile memory, associated configuration data of the application which specify those resources whose utilization is to be recorded for the application in question. It is likewise possible to install configuration data for a supplier which state the resource usages to be logged in a supplier data record for all the supplier's applications. These supplier-specific usage data can subsequently be employed to obtain useful information about the application and usage of the data carrier.

In particular when applications of a third-party supplier are installed on the security module, one must distinguish two functional application levels, namely, on the one hand, the actual service of the application utilized by a user of the data carrier, e.g. telebanking or a multimedia application, and, on the other hand, the access to resources of the data carrier required thereby. As a rule, the user can only be billed for the former since he cannot control the extent of required resource accesses, e.g. to a mobile communication network. Therefore an application can also comprise two mutually linked partial applications which each realize one of the above-mentioned functional levels almost entirely separately. The usage data from the two partial applications are then managed separately, so that the service requested by the user can be billed to him, while the required resource usage is to be billed to the supplier of the application. It is expedient here to create, besides the application and/or usage data records assigned to the supplier, user data records which log the extent of utilization of the service, of interest to the user, of the application. For example, it can be expedient to create or to update an application-related usage data record and a user-related user data record upon each recording of a resource usage in order to obtain a separation of the actual utilization of the service of an application from the resource usage required thereby.

There are diverse possibilities of organizing the usage data records in the non-volatile memory such that the assignment to the particular applications and/or suppliers is possible unambiguously. For example, it is possible to create a separate usage data record for each resource usage to thereby obtain a flexible assignment and addressability of the usage data upon the distributed evaluation of the data. Furthermore, the usage data records can, on the one hand, be stored in a central memory or memory area of the non-volatile memory in which the linkage of the usage data records to the particular application is produced via application identifications in the usage data records. Such a central memory or memory area can also be subdivided into memory subareas for a plurality of usage data records per application. On the other hand, separate memory areas can be created for each supplier and/or for each application, or separate memory subareas for the application data records belonging to the particular supplier can be created in separate memory areas for supplier data records.

The recording device is present directly on the security module, for example in the form of an operating system function or as a normal application, so as to permit an active usage data acquisition directly by the security module. This makes it possible to exclude tampering with the usage data by avoiding a security-critical data communication.

The recording device is preferably configured as a device for monitoring the accesses of the applications installed on the data carrier to the resources of the data carrier, so that the recording device performs a checking function upon execution of an application with regard to the interaction thereof with the data carrier and its resources. The usage data are created on the basis of the accesses, monitored by the recording device, of an application to the resources of the data carrier.

The recording device is preferably integrated directly into a runtime environment of the data carrier for execution of applications, or it is at least in sufficiently close interaction with such a runtime environment to ensure an effective monitoring of the applications. Said runtime environment can be e.g. an interpreter for executing interpretable applications, so that an application can be comprehensively checked upon its execution at least with regard to resource accesses. Said runtime environment into which the recording device is integrated or with which the recording device interacts is preferably integrated directly into the operating system of the data carrier. If said operating system is a Java-based operating system, e.g. the chip-card operating system Java Card, the recording device can be integrated directly into the Java runtime environment.

Additionally it is possible that the protected runtime environment not only records and logs accesses of applications to resources of the data carrier, but first checks an access authorization of an application for the requested resources of the data carrier. For example, certain resources can be reserved for certain applications and/or released by the recording device, so that the protected runtime environment realizes a security function in the control of resource accesses of applications.

The usage data resulting from resource accesses of applications can be determined by the recording device according to different criteria, e.g. as the proportionate consumption of a resource by the application in question. It is also possible, for example, to already log as a usage the loading and storing of an application, or to record the time duration of a utilization of a resource, e.g. the processor time expended upon execution of the application, or the extent of a resource access, e.g. the static memory requirement of the installed application or the dynamic memory requirement upon its execution, or the data volume that is sent and/or received via data communication interfaces of the data carrier at the instance of an application. It is likewise possible that the usage data represent the first usage of an application or the number of resource accesses of the application and/or of all applications from a certain supplier. The usage data can also be collected on the basis of temporary or permanent resource usages or as a flat rate arising at certain time intervals. In the case of a multitasking operating system it will in many cases be expedient to take account at least additionally of the execution priority of the application process causing the usage, e.g. as independent usage information or as a weighting factor of other usage data.

The portable data carrier additionally has a data communication interface, e.g. via a contact pad according to ISO 7816 for contact-type data communication, if the data carrier is a conventional chip card, in particular a mobile communication card. Further, the security module can have a USB (“universal serial bus”) or MMC (multi-media card) interface, in particular if a data carrier with a high memory capacity is involved, e.g. a (U)SIM mobile communication card equipped with a NAND flash memory. Furthermore, other data communication interfaces are also conceivable, e.g. an over-the-air interface or a near-field communication interface.

Via the particular data communication interfaces the supplier data records and/or the application data records are transferred at regular intervals or on query directly to the particular accounting center, e.g. to the particular supplier of the application and/or to the provider of the data carrier. This can involve an active transfer of the usage data records by a communication device or the recording device of the data carrier, or a release of the particular data records so that they can be retrieved by the accounting center via the communication interfaces of the data carrier. In this way the collected usage data records are made available either to the provider of the data carrier for central further processing or to the application suppliers for decentralized use. It is possible that the usage or supplier data records are prepared in the form of accounting data by the recording device to permit the resource usage caused by the particular supplier by execution of its application to be billed thereto. The usage data records can first be transferred from the portable data carrier to a background system of the data carrier provider and be distributed further from there to the particular suppliers, e.g. in the form of individual, possibly application-related accounting data. The particular data records can likewise be made available directly to the corresponding supplier.

The present invention can fundamentally be used on all portable data carriers that have a processor and sufficient memory space for the installation of applications, e.g. all forms of chip cards, such as smart cards or secure multimedia cards, or USB storage media or the like. The invention can likewise be applied to security modules firmly installed in terminals, for example SIMs in mobile stations or TPMs (Trusted Platform Modules) in PCs. In a preferred embodiment of the invention, however the recording device is realized on a mobile communication card, in particular on a (U)SIM mobile communication card. The transfer of usage data records can be effected here in the form of short messages (SMS) or via a GPRS data channel, or the usage data records can be read out by the provider and/or the suppliers via an over-the-air interface of a mobile terminal into which the mobile communication card is inserted. Resources of a portable data carrier that can be logged and/or billed are initially all hardware and software components of the data carrier that can be used by applications. Particular mention must be made of the recording of a resource consumption with regard to processor time, storage volume, transmission data volume of data communication interfaces, access to any coprocessors and the like. Furthermore, all operating system functions or producer's applications can also be considered resources whose usage is logged by the recording device.

Further features and advantages of the invention will result from the following description of inventive exemplary embodiments and alternative embodiments in connection with the figures. Therein are shown:

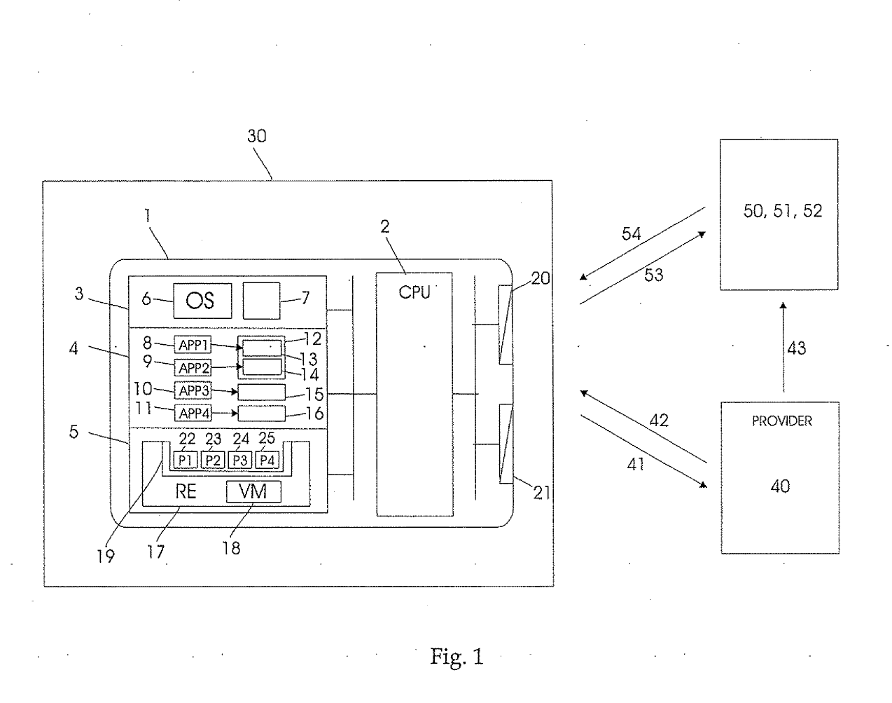

FIG. 1 a mobile communication card as an embodiment of the invention, and

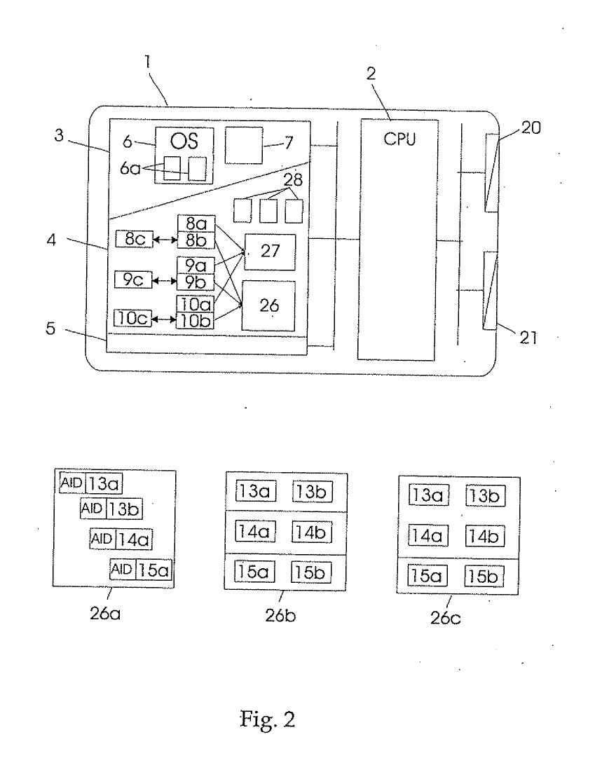

FIG. 2 further alternative and/or additional implementation variants of the embodiment of FIG. 1.

FIG. 1 shows a (U)SIM mobile communication card 1 which is inserted into a mobile terminal 30. The mobile communication card 1 possesses the usual structure of a processor chip card and comprises, besides the processor 2 (CPU), a memory hierarchy comprising a permanent ROM memory 3, a rewritable EEPROM memory 4 and a volatile RAM working memory 5, as well as one or more data communication interfaces 20, 21 for communication with an external read/write apparatus, such as the mobile terminal 30. The mobile communication card 1 can comprise e.g. a usual ISO 7816-3 communication interface 20 and be equipped as a two-chip or three-chip solution with a high-speed interface 21 which supports a high-speed transmission protocol, e.g. USB (“universal serial bus”) or MMC (“multimedia card”).

Instead of the EEPROM memory 4, the mobile communication card 1 can also have a rewritable mass memory, e.g. a NAND flash memory, which can offer a few megabytes up to one gigabyte of memory space. Accordingly, the rewritable memory 4 can store, besides the applications of the provider of a mobile communication card 1, i.e. normally the mobile network operator 40, which are installed on the mobile communication card l, further applications 8, 9, 10, 11 from suppliers 50, 51, 52 independent of the provider of the mobile communication card. Said applications from provider-independent suppliers provide a user of the mobile communication card 1 with a plurality of services that are independent of the basic purpose of the mobile communication card 1, e.g., banking services, purchasing of travel and admission tickets and management thereof customer services of department stores and similar facilities, access and identification functionalities and the like. The suppliers 50, 51, 52 independent of the provider 40 merely use the access of the provider 40 to the user via the issue of the mobile communication card 1.

While it is readily possible nowadays to expand the typical kilobyte-range storage volume of conventional (U)SIM mobile communication cards to a few megabytes, the storage volume can be expanded to the gigabyte range by means of the NAND flash technology for processor chip cards. For this reason the applications 8, 9, 10, 11 can also be relatively extensive software packages and provide the user of the mobile communication card 1 with accordingly complex services and functionalities.

It is customary to collect, both with prepaid mobile communication cards and with contractual mobile communication cards, accounting data that record the utilization of the corresponding mobile communication network. For this purpose, at least the total duration of all mobile phone calls over the mobile communication network is compiled to permit the use of the mobile communication network to be billed to the user of the mobile communication card 1 at regular intervals. These data are stored on the mobile communication card 1 in a file EF_ACM (“Accumulated Call Meter”) which represents the units of charge collected as of a certain starting time. This information is as a rule not determined by the mobile communication card 1, however, but by the corresponding mobile terminal 30 which must thus continually access the mobile communication card 1 for updating the charges. This extremely restricted logging procedure which is unsuitable for monitoring resource accesses of the applications 8, 9, 10, 11 is replaced in the present invention by a recording device 7 installed directly on the mobile communication card 1, which permits an active and tamperproof recording of the resource usages of all applications 8, 9, 10, 11 that is controlled completely by the (U)SIM mobile communication card 1, and their assignment to the individual suppliers 50, 51, 52.

For this purpose, the rewritable memory 4 sets up usage data records 12, 13, 14, 15, 16 which supply the particular usage data of the applications 8, 9, 10, 11 as recorded by the recording device 7. The usage data records 12, 13, 14, 15, 16 can serve as a basis for billing the particular resource usage to the corresponding suppliers 50, 51, 52. In the present example, the applications 8, 9 have been made available for installation on the mobile communication card 1 by the supplier 50, the application 10 by the supplier 51, and the application 11 by the supplier 52. The resource usage of all applications 8, 9, 10, 11 of each individual supplier 50, 51, 52 is itemized in each case in one of the associated supplier data records 12, 15, 16. In this way a short message (SMS) generated by a certain application 8, 9, 10, 11, for example, can be assigned and billed to the correct supplier 50, 51, 52 in a simple manner over the mobile communication network in question. Furthermore, it is also possible to monitor accesses to all other resources of the mobile communication card 1, e.g. to the processor 2, to memories 4, 5 or data communication interfaces 20, 21.

Possible expedient applications 8, 9, 10, 11 which can be installed on a mobile communication card 1 are e.g. multimedia applications, banking applications for mobile handling of banking transactions and payment processes, management applications for access data and identity data, travel tickets and the like, or customer applications for customer-specific information or local advertising of department stores, etc. If the applications 8, 9, 10, 11 perform communication with external devices, this can be handled both via the conventional contact-type mobile communication interface 20 and via a contactless interface provided with an antenna. In particular, it is possible upon the recording of resource accesses by the application 8, 9, 10, 11 to log both the static resource usage, e.g. the memory requirement of the particular application 8, 9, 10, 11 upon its installation, and the dynamic resource usage, e.g. the working memory usage or the data volume of messages or data packets sent or received via a high-speed interface 21 or via a contactless or near-field communication (NFC) interface.

The determined usage data records 12, 13, 14, 15, 16 can be sent either by the mobile communication card 1 or its recording device 7 actively to a background system of the card provider 40 and/or one of the suppliers 50, 51, 52. The data records 12, 13, 14, 15, 16 can likewise be released by the recording device 7 in a passive manner to be queried by the provider 40 or a third-party supplier 50, 51, 52. An active sending 41, 53 of the data records 12, 13, 14, 15, 16 can then be effected for example via the mobile communication network in the form of short messages (SMS) or via corresponding functionalities of the “SIM Application Toolkit”, while the data records 12, 13, 14, 15, 16 can be passively released for collection by an access 42, 54 to the corresponding data via an over-the-air interface of the mobile terminal 30.

While the recording device 7 can also be stored as an application in the rewritable memory 4, the operating system 6 (OS) of the (U)SIM mobile communication card 1 is preferably expanded by the functionality of the recording device 7, so that upon execution of an application 8, 9, 10, 11 as an application process 22, 23, 24, 25 (P1, P2, P3, P4) a suitable, protected runtime environment is available therefor in the operating system 6. Said runtime environment 17, 18, 19 can provide, besides the actual updating of the usage data records 12, 13, 14, 15, 16, also a security functionality upon execution of the application processes 22, 23, 24, 25 in that the activities thereof are monitored and the resource accesses thereof checked, logged and possibly rejected if there is no access authorization and/or release. In particular, the runtime environment 17, 18, 19 checks all accesses of application processes 22, 23, 24, 25 to the data communication interfaces 20, 21 of the (U)SIM mobile communication card 1, e.g. by monitoring accesses to UART buffer memories (not shown) which are up-stream of the data communication interfaces 20, 21 for synchronization of data inputs or outputs, or directly to the contact-type interface 20 or a high-speed interface 21.

Since the protected runtime environment 17, 18, 19 is disposed between the running application processes 22, 23, 24, 25 on the one hand and the requested resources on the other hand, the dynamic resource usage, the data transmission volume or the number of transferred data packets can be determined in application-specific and reliable fashion by the recording device 7 or the corresponding recording device process 19 and stored in the supplier data record 12, 15, 16 of the corresponding supplier 50, 51, 52.

The (U)SIM mobile communication card 1 is preferably a Java mobile communication card on which the operating system 6 Java Card is installed, so that in particular the applications 8, 9, 10, 11 are Java applets (APP1, APP2, APP3, APP4) which are executed by a Java interpreter or a Java Virtual Machine 18 (VM). The recording device 7 is so integrated into the Java Card operating system 6 that upon its execution as a recording device process 19 it enters into the Java runtime environment 17 (RE) which also comprises the Java Virtual Machine 18. The Java runtime environment 17 or the integrated recording device process 19 can assign the resource usage via an application identification (AID) to the corresponding application 8, 9, 10, 11 causing the resource usage.

The recording device 7 can further be so configured that the determined usage data records 12, 13, 14, 15, 16 are sent either regularly, e.g. after 1000 “GSM STATUS” commands, or event-dependently, e.g. upon an SMS point-to-point data download, to a background system of the mobile communication card provider 40 or directly to the particular supplier 50, 51, 52. This can be effected for example by means of the command “Send SMS” from the “SIM Application Toolkit”. Furthermore, there is a large selection of different possibilities for recording resource usage data, e.g. volume- or time-dependently, according to the number of resource accesses or also by flat rate. Upon a flat-rate determination of the usage data, this can be charged as a one-time or time-dependent flat rate, e.g. as a monthly flat rate.

The usage data can be used not only for accounting purposes but also for other purposes, e.g. for statistical evaluation of the behavior and the use of application 8, 9,10, 11 and the like.

FIG. 2 illustrates on the basis of a (U)SIM mobile communication card 1 a few further implementation variants of the invention which can be used in addition or as an alternative to the features of the invention explained with reference to FIG. 1. The mobile communication card 1 can be inserted into a mobile terminal 30 and interact therewith here in the same manner as described in FIG. 1. Identical reference signs also designate identical features in the two figures.

The recording device 7 records usage data which represent a usage of resources 2, 4, 5, 6a, 20, 21, 28 of the mobile communication card 1 by the applications 8a, 8b; 9a, 9b; 10a, 10b. The usage data are stored in a specially provided memory area 26 of the non-volatile memory 4 and finally transferred to an accounting center for evaluation and accounting. For recording the usage data, the recording device 7 determines that application 8a, 8b; 9a, 9b; 10a, 10b that has caused the resource usage in question and stores the usage data in a certain assignment to a consumption data record 13a, 13b, 14a, 14b, 15a, 15b which is linked to the causing application 8a, 8b; 9a, 9b; 10a, 10b. It is not necessary, however, that the consumption data are stored in the corresponding consumption data record 13a, 13b, 14a, 14b, 15a, 15b, but rather any form of assignment between the collected consumption data and an already stored consumption data record is possible, e.g. references, identification marks, complex and addressable data structures and the like. The consumption data collected upon each recording can likewise also be stored as separate usage data records besides already recorded usage data records 13a, 13b, 14a, 14b, 15a, 15b and linked in identifiable fashion.

Resources 2, 4, 5, 6a, 20, 21, 28 whose usage is logged by the recording device 7 can fundamentally be all hardware and software resources of the mobile communication card 1. Hardware resources are e.g. the processor 2, the non-volatile memory 4, the RAM working memory 5, communication interfaces 20, 21 or the like, while software resources are primarily modules and functions 6a which the operating system 6 of the mobile communication card 1 provides, but also other applications 28 installed on the mobile communication card 1 which were not provided in the non-volatile memory 4 by the supplier of the particular application 8a, 8b; 9a, 9b; 10a, 10b causing the particular resource usage.

The type of usage of the resources 2, 4, 5, 6a, 20, 21, 28 can also be different. Besides the above-mentioned types of usage it is possible to record the loading of a new application 8a, 8b; 9a, 9b; 10a, 10b onto the mobile communication card 1, the storage of the application 8a, 8b; 9a, 9b; 10a, 10b in the non-volatile memory 4 as well as the first execution thereof as a usage e.g. of the memory 4 and/or of the communication interfaces 20, 21 and/or of the processor 2. In any case it is expedient to register the proportionate consumption of a resource 2, 4, 5, 6a, 20, 21, 28 by an application 8a, 8b; 9a, 9b; 10a, 10b in relation to the total extent of the resource 2, 4, 5, 6a, 20, 21, 28 or to the usage of the resource 2, 4, 5, 6a, 20, 21, 28 by other applications 8a, 8b; 9a, 9b; 10a, 10b. If the mobile communication card 1 has a multitask- or multithread-capable operating system 6 which can execute a plurality of processes concurrently, it is expedient in this connection to record the execution priority of the corresponding application process as a resource usage, since the latter represents a preferred execution of the particular application 8a, 8b; 9a, 9b; 10a, 10b by the processor 2, which can be billed to a supplier.

The applications 8a, 8b; 9a, 9b; 10a, 10b can consist in each case of two partial applications whose resource accesses are recorded separately. One of the partial applications 8a, 9a, 10a realizes the actual service utilized by the user of the mobile communication card 1, e.g. an online banking transaction via WAP (“Wireless Application Protocol”), a biometric identification or any multimedia application, such as the loading or playing of digital audio or video data or the like. This service requested by the user can then be billed to him. The other one of the partial applications 8b, 9b, 10b realizes the accesses to the resources 2, 4, 5, 6a, 20, 21, 28 of the mobile communication card 1 that are necessary for providing the service of the first partial application 8a, 9a, 10a. These resource usages triggered by the user's request, which cannot be billed to the user since as a rule he cannot survey and control the extent thereof, are billed to the supplier of the application 8a, 8b; 9a, 9b; 10a, 10b. Therefore it is expedient to record the extent of the utilization of services deriving from the partial applications 8a, 9a, 10a in user data records separately from the usage data records 13a, 13b, 14a, 14b, 15a, 15b deriving from the partial applications 8b, 9b, 10b. The user data records are also stored in the non-volatile memory 4, e.g. in a separate user data memory area 27. It is thus possible for example to store upon the execution of an application 8a, 8b; 9a, 9b; 10a, 10b in each case an application-related usage data record 13a, 13b, 14a, 14b, 15a, 15b in the usage data memory area 26 and a user-related user data record in the user data memory area 27 to thereby separate the usage data attributable to the supplier and to the user.

The organization of the usage data or of the usage memory area 26 can be effected not only in the way shown in FIG. 1 but also in diverse other ways so as to permit an assignment of collected usage data to usage data records 13a, 13b, 14a, 14b, 15a, 15b and applications 8b, 9b, 10b or suppliers. On the one hand, a central memory area 26a can be created for the usage data records 13a, 13b; 14a, 14b; 15a, 15b of all applications 8a, 8b, 9a, 9b, 10a, 10b. The individual usage data records 13a, 13b; 14a, 14b; 15a, 15b can then be assigned to the particular application by any mechanism, e.g. by an application identification AID stated in the usage data record 13a, 13b; 14a, 14b; 15a, 15b.

On the other hand, a memory area 26b for usage data can also be divided up into application-specific memory areas which are assigned in each case to an application 8a, 8b; 9a, 9b; 10a, 10b. In the outlined memory area 26b there is set up for each application 8a, 8b; 9a, 9b; 10a, 10b an area in which the usage data records 13a, 13b; 14a, 14b; 15a, 15b of the corresponding application 8a, 8b; 9a, 9b; 10a, 10b are stored in each case. Furthermore, it is likewise possible to provide a usage data memory area 26c which divides up the usage data records 13a, 13b; 14a, 14b; 15a, 15b not according to the causing applications but according to the suppliers that have provided said applications 8a, 8b, 9a, 9b, 10a, 10b on the mobile communication card 1. The usage data records 13a, 13b, 14a, 14b of all applications 8a, 8b; 9a, 9b deriving from the same supplier are then stored in a common memory area. Any kind of memory organization or data structure is fundamentally possible that allows the assignment of usage data records 13a, 13b; 14a, 14b; 15a, 15b to those applications 8a, 8b, 9a, 9b, 10a, 10b that have caused the corresponding resource usage. Therefore it is e.g. also possible to set up separate memory areas for each supplier and each application as well as separate memory areas in the particular memory area of an application.

It can be expedient not always to record every resource usage upon an application 8a, 8b, 9a, 9b, 10a, 10b, but only usages of certain given resources 2, 4, 5, 6a, 20, 21, 28, e.g. to minimize the overhead or to provide certain resources 2, 4, 5, 6a, 20, 21, 28 as a basic infrastructure without accounting. This can be obtained both for applications 8a, 8b; 9a, 9b; 10a, 10b and for suppliers individually by configuration data records 8c, 9c, 10c which are loaded onto the mobile communication card 1 with the particular application 8a, 8b; 9a, 9b; 10a, 10b. The configuration data records 8c, 9c, 10c are read out by the recording device 7 and carry information about which resources 2, 4, 5, 6a, 20, 21, 28 are to be monitored and billed to the supplier in question,

Although the exemplary embodiments explained above relate to mobile communication cards, the present invention is not restricted to such portable data carriers but can be used for all security modules equipped with a processor and sufficient memory space, such as secure multimedia cards, conventional chip cards or also USB storage media or the like. The security module can also be firmly installed in a terminal. Besides the classic applications of chip cards, e.g. as an electronic purse, credit card, admission ticket, etc., the present invention is therefore applicable in particular also in connection with multimedia data carriers which manage any multimedia data and their access rights and are e.g. in interaction with databases on the Internet for loading and using multimedia data temporarily or permanently. In this application scenario as well, the present invention permits the unique linkage of the corresponding service to a secure payment by the user or to the corresponding suppliers of the multimedia data or multimedia applications.

1. A method of operating a security module, comprising the steps of:
recording usage data representing a usage of resources of the security module;
storing the usage data in a non-volatile memory of the security module;
transferring the stored usage data to an accounting center; and
determining an application stored on the security module that is causing the resource usage represented by the usage data and by the usage data being stored, in the storing step, in their assignment to the determined application.

2. The method according to claim 1, wherein there is present in the non-volatile memory a usage data record linked to the application and to which the determined usage data are assigned and which is transferred to the accounting center.

3. The method according to claim 1, wherein the application is an application provided on the security module by a supplier independent of a provider of the data carrier, and in the non-volatile memory there is present as a usage data record a supplier data record linked to the supplier and to which the usage data caused by the application are assigned.

4. The method according to claim 1, wherein the determined application comprises two mutually linked partial applications, one of the partial applications realizing a service utilized by a user of the data carrier and the other of the partial applications causing the resource usage.

5. The method according to claim 1, wherein there is present in the non-volatile memory a user data record linked to the user and to which an extent of utilization of the service is assigned.

6. The method according to claim 1, wherein a separate usage data record and/or a separate supplier data record and/or a separate user data record is created for each recorded resource usage.

7. The method according to claim 6, wherein the usage data record and/or the supplier data record and/or the user data record is actively transferred to the supplier and/or the provider as the accounting center, or made available on the security module for retrieval by the accounting center.

8. The method according to claim 1, wherein the usage data record is stored in separate memory areas for each application and/or each supplier or in a common memory area.

9. The method according to claim 1, wherein there is present on the security module for at least one application and/or for at least one supplier a configuration data record stating the resource usages to be recorded for the corresponding application.

10. The method according to claim 1, wherein the resources comprise hardware components of the data carrier, said hardware comprising a processor, memory, data-transmission capacity and/or communication interfaces, and/or software components of the data carrier.

11. The method according to claim 1, wherein usage data are recorded that represent a proportionate consumption of a resource by the application, including a duration and/or an extent and/or a number of resource accesses of the application.

12. The method according to claim 1, wherein usage data are recorded that comprise an execution priority of the executed application.

13. The method according to claim 1, wherein the usage data record is prepared in the form of accounting data, and the resource usage caused by the application is billed to the corresponding supplier with the help of the accounting data.

14. A security module, comprising a non-volatile memory, resources, a recording device arranged to record usage data representing a usage of the resources caused by an application present on the security module and to store them in the non-volatile memory; a communication device arranged to transfer the stored usage data to an accounting center, wherein the recording device is adapted to determine the application that is causing the resource usage represented by the usage data, and to store the usage data in the non-volatile memory in their assignment to the determined application.

15. The security module according to claim 14, adapted to execute a method according to claim 1.

16. A security module according to claim 14, wherein the recording device comprises a protected runtime environment that checks the execution of the application by a processor of the data carrier.

17. The security module according to claim 16, wherein the protected runtime environment is integrated into an operating system of the data carrier.

18. The security module according to claim 16, wherein the operating system of the data carrier is a Java operating system, and the protected runtime environment is integrated in a Java runtime environment of the Java operating system.

19. The security module according to claim 16, wherein the protected runtime environment is adapted to allow, upon execution of the application, only usages of resources that are reserved or released for the application.

20. The security module according to claim 14, including a high-speed data communication interface.

21. The security module according to claim 14, wherein the security module is a (U)SIM mobile communication card and/or the non-volatile memory is a mass memory for storing applications.

22. The security module according to claim 14, wherein the security module is firmly installed in a terminal.

23. A system comprising an accounting server, a terminal and a security module according to claim 14.
